(19) United States
(12) Patent Application Publication
(10) Pub. No.: US 2013/0138462 A1
(43) Pub. Date: May 30, 2013

(54) SYSTEM AND METHOD FOR CLOUD-BASED WEB ENABLED DATABASE DRIVEN BLIND REVERSE MARKET

(71) Applicants: THOMAS J LOVE, JR., Cromwell, CT (US); Paul F James, Ware, MA (US)

(72) Inventors: THOMAS J LOVE, JR., Cromwell, CT (US); Paul F James, Ware, MA (US)

(21) Appl. No.: 13/482,590

(22) Filed: May 29, 2012

Related U.S. Application Data
(60) Provisional application No. 61/490,997, filed on May 27, 2011.
(60) Provisional application No. 61/490,101, filed on May 26, 2011.

(51) Int. Cl. G06Q 30/06

(52) U.S. Cl. CPC G06Q 30/0605
USPC 705/7.13; 705/26.2; 705/7.25

(57) ABSTRACT

The described embodiment of the system includes business methods and software and hardware that operate a confidential reverse blind market in industrial goods that matches buyers and sellers in a confidential manner and enables trade in goods traded in long term supply chains. In addition, the system provides a complete system of supply chain tracking from pre-order planning through ordering, production, seller shipping, buyer shipping, and inventory forecasting.

### CROSS-REFERENCE TO RELATED APPLICATIONS

This application claims the benefit of Provisional Patent Application Docket No. 61/488,596, Provisional Patent Application Docket No. 61/490,101, U.S. Provisional Patent Application Docket No. 61/494,465 and U.S. Provisional Patent Application Docket No. 61/490,997 which is incorporated by reference.

### BACKGROUND OF THE INVENTION

1. Field of the Invention

This provisional patent application relates to cloud computing, automated blind reverse markets in long term supply chains, process manufactured goods such as aluminum, steel, oil and similar products, and supply chain tracking and forecasting of inventory consumption and production as they relates to long term supply chains using multiple sources and routes, and related software and business methods.

2. Description of Related Art

### Online Industrial Markets

Web based commercial and industrial marketplaces have many serious deficiencies, which render them of little or no use in real world buying for industrial supply.

In real world markets, a potential buyer seeking new sources of supply contacts each potential supplier separately and confidentially. Each potential supplier receives only that information which the buyer is willing to share, and does not know of the buyer=s contacts with other potential suppliers. This information asymmetry favors buyers. In contrast, in online markets where buyers post interest, all suppliers and buyer competitors see the buyer=s posting, and can draw detailed product plans about the buyer=s future intentions from examining what supply the buyer is interested in obtaining.

In real world markets, a supplier who is seeking to replace a customer, has lost a customer, or is trying to enter new markets, can control knowledge of its plans by carefully controlling its contacts with potential customers. Knowledge of the suppliers actions can be controlled by the supplier to a large degree. In contrast, on an online market, supplier postings are public, and supplier intentions can be readily gleaned by competing suppliers and potential and existing customers. This can be a significant disadvantage to the supplier.

Online markets are poor at indicating intensity. Especially in process industries such as aluminum, steel, chemicals and any other business where long production runs are key to profitability, a buyer or seller can be capable of selling a wide array of products, but may have strong interest in certain products at certain future dates because those dates are part of an already scheduled production run for that product. Lengthening that production run will disproportionately increase the profitability of that run. However, online markets tend to compel buyers and sellers to list potential capabilities, that is, all of their products, whether or not the buyer/seller is strongly interested in them at that moment. In addition, indicating strong interest for a particular product in a particular time frame invites stronger price negotiation by the other parties, since strong interest means strong profitability which means room for price negotiation.

Online markets are inefficient at conveying contextual information. Buyers and sellers list their entire product lines, and receive inquiries on their entire product line, even though they may have little interest in selling a particular product at a particular time, or have no ability at all in the desired time frame. Thus, online markets increase the amount of wasted inquiries. In addition, the very nature of online markets means they are almost universally selling listings, as the sellers are generally always selling, whereas buyers are only episodically buying. Thus, it is the buyers who have to do the searching in the marketplace, which a reversal of the real world, where generally it is the sellers which do the sales prospecting.

### Supply Chain Management Systems

Supply chain software generally has serious limitations when applied to long term, complex supply chains.

One serious deficiency is the inability to manage multi party collaboration in a secure environment. Most supply chain software is binary, that is, only the buyer and the seller can interact in the system (the systems being typically controlled by the buyers). Intermediaries, shippers, customs, and other parties have no access to the system because the systems are not designed to permit multiparty, controlled, secured access.

Another deficiency is time frame. Most supply chain software covers the actually shipping portion of the supply chain, and some covers restocking orders by tracking actual inventory levels. But in long term supply chains (multiple year), the entire process needs to be scheduled and tracked, that is pre-order planning, order scheduling, order placement, production scheduling, seller shipping, and last buyer shipping. All of this must be tracked in order to manage long supply chains over time.

Another deficiency is the inability to combine part numbers from separate manufacturers into a single stream. Supply chain software cannot generally combine multiple supplier sources into a single stream, because supplier part numbers differ, and because of the binary security model mentioned above (only one buyer and one seller).

Another deficiency is that the tracking system is limited to a single carrier (UPS, Evergreen, etc.)

Because supply chain software has the foregoing deficiencies, it cannot be used to forecast long term supply chain inventory levels, and cannot forecast supply disruptions accurately. Early and accurate warning of long term disruptions are crucial to mitigating such disruptions.

Another deficiency is the inability to manage complex event chains related to complex hierarchical projects.

### BRIEF SUMMARY OF THE INVENTION

The embodiment of the system described herein consists of software, hardware and systems comprising all of the elements cross referenced patents.

### The Marketplace

The confidential reverse market system (ACRMS@) works on principles that address the shortcomings of the existing marketplaces. First, no buyer or seller postings (Ainquiries@) are made public. Instead, the CRMS matches buyer and seller postings as they are made. When a match is found, the buyer is first notified that there are sellers who have matching inquiries, and the buyer is given an indication of closeness of fit of the matches, and the bare identities of the sellers. The buyer can then decide to proceed or not with each seller (and thereby disclosing to an existing supplier that the buyer is in the marketplace). The sellers who are selected are notified that a buyer has matched one or more of their inquiries, which enable the seller to determine the sellers interest level, since the seller knows the relative importance of its various inquiries. If the seller agrees to proceed, then the buyer=s actual inquiry is delivered to the seller for further negotiation.

The CRMS enables buyers and sellers to post inquiries for their complex long term supply chain needs without disclosing confidential information to anyone. Sellers can immediately enter the marketplace to seek buyers that would lengthen production runs, without giving away any information as to why their inquiry was made. Suppliers can post their entire optimized production schedule in a marketplace, but in complete secrecy. Buyers likewise can source supply for new products, or replace suppliers, or change production schedules without revealing any of these changes.

### Supply Chain Management System

The forecasting supply chain collaboration system has (AFSCCS@) two parts: long term collaborative manufactured goods tracking system, and the flexible collaborative goods and services system.

The long term manufactured goods collaborative supply chain tracking and forecasting system is based on the associated U.S. Provisional Patent Application No. 61/489,596. The system tracks pre order planning, order scheduling, order placement, production, seller shipment and buyer shipment in separate but connected modules. Thus, the system can allow access to any user in any role to just those parts of the chain that they need access to. The system constantly monitors the projected completion date of each step and issues warnings where needed. The system also includes an inventor level module, which forecasts current inventory with expected production, matched against the supply chain tracking module, thus being able to predict out-of-allowable limits on inventory months and years in advance. And the system applies a forecasting part number to all items in the system, independent of buyer and seller part numbers, enabling the combination of multiple suppliers into a single forecast.

The flexible collaborative goods and services system reduces complexity by not separately tracking production and delivery. It adds flexibility by making purchase orders and purchase order items hierarchical and therefore in a more dependent project management style, and by building out the calendar task system into one that more explicitly tracks deliveries, payments and approvals. It has all the other features of the other system.

### BRIEF DESCRIPTION OF THE DRAWINGS

FIG. 1 is an overview of the components of the confidential reverse market system.

FIG. 2 describes the components and process of the market object system.

FIG. 3 is an overview of the components of the forecasting supply chain collaboration system.

FIG. 4 describes the overall long term goods production, tracking and forecasting process.

FIG. 5 describes the long term manufactured goods supply chain collaboration system in detail.

FIG. 6 describes the flexible goods and services collaboration supply chain system in detail.

### DETAILED DESCRIPTION OF THE INVENTION

### Confidential Reverse Markets/Overview

This portion of the description is related to the confidential reverse market system. The CRMS is an industrial oriented marketplace designed around the following principles, which are in contrast to marketplaces typical of the Web:
confidentiality—seller inquiries are never disclosed to anyone, and buyer inquiries are disclosed only to actively interested sellers and then only after the buyer is notified of the identity of interested sellers and the buyer approves the seller and only, initially by the seller, to the extent necessary to evaluate the offer (i.e. no identifying information about the buyer)
actual interest—in contrast to listing style services, where a large number of potential sellers are presented to the buyer, and the buyer must contact each seller to determine actual interest, this system requires that each seller evaluate a buyer inquiry and indicate active interest, before the buyer has to further proceed with the inquiry
continuous automated evaluation—the job executable continually evaluates existing inquiries against new inquiries for as long at the posting user requests—once the inquiry is set up and the inquiry period specified, no further user interaction is required.

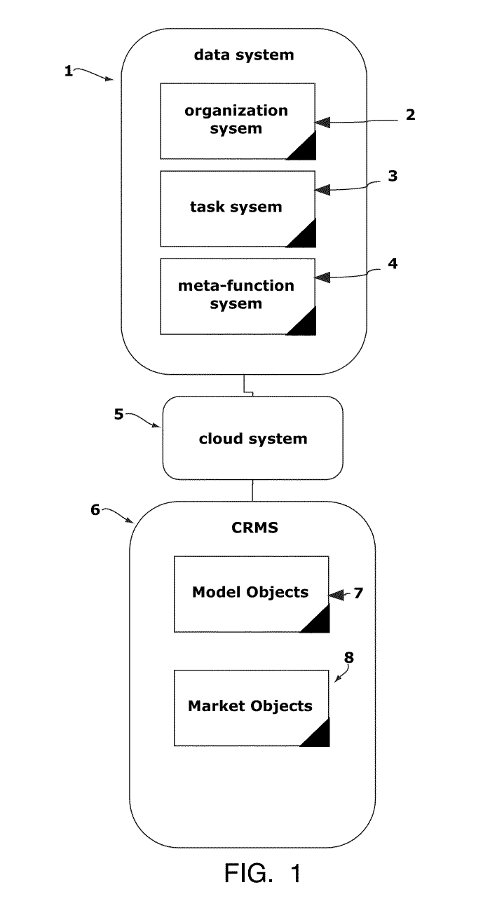

FIG. 1 is an overview of the components of the confidential reverse market system.

FIG. 1, data system, item 1. All components of the data system described in the associated U.S. Provisional Patent Application No. 61/489,596 are used in this system. Special note is taken the multi-level organization system, the task system, the job system and the meta-function system is described in the cross referenced application. Particular use is made of zero parent row system.

FIG. 1, data system, organization system, item 2. The organization system anticipates large multi organizational unit (AOUnit@) multi-level systems, and single level small organizations. This is supported by a single OUnit table using the parent row zero feature described in the associated U.S. Provisional Patent Application No. 61/489,596. Organizations in the CRMS are buyers, sellers, intermediaries or service providers.

Users join the system either by signing themselves up or by being signed up by an existing user with authority to do so. If the user is signing themselves up, they are added to a new OUnit. If they are signed up by an existing user, then the new user is assigned to the existing user=s OUnit or a child OUnit thereof. Organizational membership is confidential, but organizations can link by sending email requests through the system.

The system is presented to end users as Organization (parent OUnit)/OUnit. It is required that all users be associated with at least one organization/OUnit chain. The OUnit users will generally be either the sales force of sellers or the purchasing agents of buyers.

FIG. 1, data system, task system, item 3. The task system in this embodiment specifically groups tasks into buyer or seller. The system uses the task system=s grouping mechanism to offer generally two roles, administrator and user. Administrators can create users and child OUNITS. Users can be assigned market participation tasks. Users can have tasks assigned to them, and optionally the ability to assign the same tasks to others. Tasks follow the hierarchy of Organization Unit/User. Tasks are generally add/edit/view/delete objects in the system. These objects are buy and sell inquiries, and collaboration objects. Tasks are thus generally create buy and sell inquiries, and evaluate and follow up on matches, i.e., accept, reject, start collaboration.

FIG. 1, data system, meta function system, item 4. All features of the meta function system are used but a particular emphasis is placed on the following elements.
Spreadsheet integration: the system enables direct spreadsheet integration in the buy/sell process
Collaboration: collaboration is used in connection with each element of the market system.
File sharing: The file system is used to deliver production (such as CAD drawings) and financial information.
Task tracking and auditing: task tracking and audit is used in connection with posting buy and sell inquiries and subsequent management and collaboration.

FIG. 1, cloud, item 5. The cloud system is described in the cross referenced U.S. provisional patent application 61/494,465. It is used herein in its entirety.

FIG. 1, CRMS, item 6. The CRMS is the data structures and interactions with the data system, job and task system, as well as the other features of the other aforementioned elements, that manage and organize the interaction of the users of the system in a confidential reverse market context.

FIG. 1, CRMS, model objects, item 7. Model objects model the product being offered in the marketplace. There are two models, buy inquiries and sell inquiries. By their nature, buy inquiries are more specific than sell inquires. Sell inquiries accommodate ranges in many values, since sellers can produce products with a variety of qualities, whereas buyers tend to want a specific item.

The model inquiry object is a parent/child table set, with the child table being a zero parent table, and attribute data tables used to hold the data entered by a buyer or seller. The model objects are set up by the administrative staff of the system.

Table 1 describes the model object tables.

TABLE 1

| table | description | |
|---|---|---|
| Market table | This table organizes each of the product markets. It includes a description | |
| | of the product exchanged in the market. | |
| OUnit link table | OUNITS are authorized by the administrative staff of the system to trade in | |
| | specific markets. The OUNITS manage users tasks themselves (which users | |
| | can actually trade). | |
| Master attribute | This table provides the model for each attribute, whether the attribute is | |
| table | mandatory or optional, and the hierarchical chain of child attributes. | |
| | market id field | link to market table |
| | parent id field | 0 for top level attributes, parent row id for child attributes |
| | buyer description | description of attribute tailored for buyers |
| | seller description | description of attribute tailored for buyers |
| | required status | optional, mandatory, mandatory with link to an alternative |
| | | attribute |
| | must match status | must the buyer and seller values match or is this a closeness |
| | | of fit attribute |
| attribute data | This table is part of both the model and the actual market object. It informs | |
| table | the model of what data comprises the attribute, and in the actual market | |
| | stores the data. It handles all forms of attribute data. | |
| | link to master attribute | This is a one to one link to the master attribute table |
| | table field | |
| | presentation order | This is the order in which the attributes should be presented |
| | | to the user. |
| | Mandatory status | This indicates mandatory status - 1 not shown to buyer, 2 |
| | | non mandatory for buyer, 4 mandatory for buyer, 8 children |
| | | also mandatory for buyer, 16 not shown to seller, 32, non- |
| | | mandatory for seller, 64, mandatory for seller, 128, children |
| | | also mandatory |
| | parent zero | The parent zero determines whether this is a top level |
| | | attribute or a child attribute of another attribute. |
| | data fields | These fields are necessary to capture the data related to the |
| | | attribute and to enforce min/max or other limits. Data |
| | | fields are provided for both buyers and sellers, because |
| | | sellers are typically looking for specific elements while |
| | | sellers are typically looking for ranges. |
| | | The data fields consist of two fields for the buyer, and two |
| | | for the seller. The first of the two fields contains a directive |
| | | language developed by the inventors to frame questions to |
| | | the buyer and seller, and the second of the two fields holds |
| | | the buyer = s and seller = s answers]. |
| | | The directive language works as follows. The syntax of the |
| | | first directive is the following separated by pipes: |
| | | question in English |
| | | help/hint in English |
| | | data type of answer - uses SQL data types |
| | | list table to get list from, or insert the list, or null integer |
| | | number of items that can be selected, 0 means all |
| | | variable name for answer - to be used in validation |
| | | validation code to check answer, if from a list null, if text |
| | | then not null or null - supports code in any language to |
| | | validate the entry |
| | | validation error text in English |
| | | #or @, # means next directive (many directives can be |
| | | chained) @ means a qualifier directive for the preceding |
| | | directive, e.g. first directive is gauge in inches or |
| | | millimeters, second directive is choice between millimeters |
| | | and inches. |
| | | An example - gauge must be in inches, and be between .04 |
| | | and .08 inches, or in millimeters between 1 and 2: |
| | | Please enter the gauge of your inquiry\|Gauge can be in |
| | | inches between .04 an .08 or in millimeters between 1 and |
| | | 2\|decimal,0,4∥gauge\|if units == “mm” |

if gauge >=1 && gauge <= 2 then result = 1

else result = 0

else

if gauge >= .04 && gauge <= .08 then result = 1

else result = 0

end if|
Validation error: gauge must be between .04 and .08 inches
or between 1 and 2 millimeters
@
Please select inches or millimeters|Please select inches or
millimeters|text,2|L:in mm|units∥
A third field is the code to match the buyer entry to the
seller, as above, with error text in English for reporting a
mismatch.
The web application parses the language, presents it to the
user and records the answer.

| | |
|---|---|
| Lookup table | These tables stores lookup (lists) to use in attribute data. |

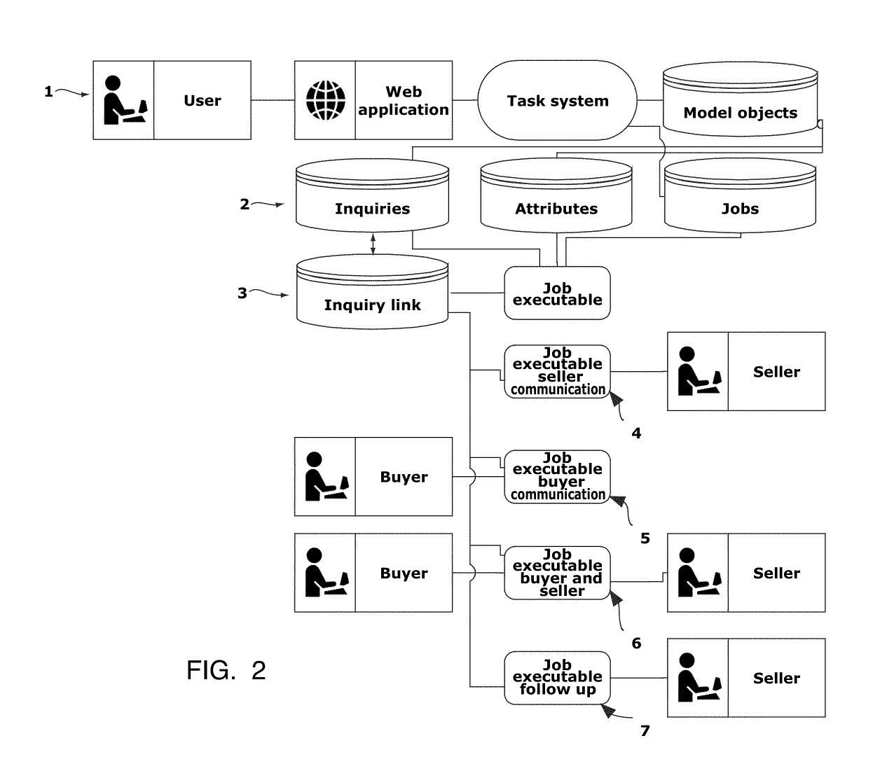

FIG. 1, CRMS, market objects, item 8. The market objects comprise the actual market. When a buyer or seller posts an inquiry, the rows in the model object tables are reproduced in the market object table with the actual values specified by the user. FIG. 2 describes the components of the market object system.

FIG. 2, web application, item 1. The web application directs the buyer/seller user once the user has selected a market, and then refers to the task system and the model object.

FIG. 2, model system, item 2. The web application guides the user through the creation of an inquiry and the establishment of the attributes for the inquiry. The web application creates the inquiry row and then the associated attribute objects, and, once the user has completed the inquiry, inserts the users specifications into the inquiry table and the attribute table and signals the job executable for further processing. A buyer specifies the product and characteristics that the buyer is seeking, and has no access to any other buyer or seller inquiries. A seller posts standing generalized sell inquiries, and likewise has no access to any other buyer or seller inquiries.

The inquiry table is the organizing table for all inquiries, both buy and sell. It also holds general inquiry data such as date ranges (starting effective date, ending effective date) and whether the inquiry is complete and active. The child table holds the data values from the model object. The task system handles presentation, tracking hierarchy paths and values, and if then logic among the items.

The various attribute tables are joined to the inquiry table by the model inquiry object and the web application. Buyers and sellers are directed through the required attributes and the parent child hierarchy by the web application reading the model inquiry object.

FIG. 2, inquiry link table, item 3. The inquiry link table is used to link buy and sell inquiries and to record their match evaluation value. When a buy or sell inquiry is completed, the job system immediately adds link rows to the link table between the new inquiry and each then currently active opposite inquiry in that market (buys matched to sells, sells match to buys). Each buy/sell link is evaluated and scored:
mandatory match attributes are checked first
if any mandatory match factor doesn=t match, the inquiry is marked as failed with the failing factor noted in the match row and further checking ceases
closeness of fit factors are then checked
the result of each factor check is recorded in the match table

FIG. 2, job executable match evaluation—seller communication, item 4. When the system finds a match between a buyer inquiry and a seller inquiry, the system sends the non-identifiable buyer inquiry information to each seller separately (meaning all of the buyer inquiry information that doesn=t identify the buyer—no geographic information, no names). This enables sellers and buyers to focus only on inquiries in which they have actual current interest. each seller must then independently (and secretly) indicate whether the seller would like to proceed.

FIG. 2, job executable match evaluation, buyer communication, item 5. The names (only) of the accepting sellers are sent to the buyer for the buyer to indicate acceptance or rejection of the seller (to avoid buyer embarrassment by sending new orders to an existing supplier through an anonymous online market). The sellers are ranked by closeness of fit.

FIG. 2, job executable match evaluation, buyer and seller, item 6. The buyer=s full inquiry is sent to those sellers (separately) who are approved by the buyer.

FIG. 2, job executable match evaluation, follow up, item 7. The inquiry link table records the result of each match permanently. The sellers receive a daily summary of failed orders, so they have the opportunity to fine tune their inquiries to meet market activity. This keeps sellers informed of trends in the marketplace while at the same time maintaining buyer confidentiality.

It should be noted that
neither the buyers=identity nor the sellers=identity is generally disclosed
at no time are the contents of a seller=s inquiry disclosed
a seller=s identity is disclosed to a buyer only after the buyer has posted an inquiry which matches a seller=s inquiry and in which the seller has actual interest
the buyer=s inquiry is disclosed only to sellers who have matching inquiries
the buyer=s identity is disclosed only at the direction of the buyer to sellers who have already indicated an interest in the buyer=s inquiry and whose identities have already been disclosed to the buyer

### Confidential Reverse Markets Systems/Embodiments of Reverse Markets

The inquiry attributes for both buyers and sellers are the same. However, the sellers will tend to make broader inquiries covering greater time periods where time periods are a factor, and greater quantities where quantities are a factor, and ranges rather than specific values, when ranges are a factor. Markets can include both process and spot markets. Process markets are industrial markets where the product is made by a continuous process. Examples are oil, steel, aluminum. Profitability in these markets is determined by break down and set up time between runs of a single product type. The longer the runs and the fewer product switches, the more profitable (and lower cost) the product. Spot markets are markets of single transactions, which are not directly part of a continuous production process. Profitability in these markets is determined by anticipating demand, and profits and buyer cost vary inversely. Market specifications can also be hierarchal (that is, attributes can be specified with increasing precision) or flat (all specifications are at the same level). Service markets tend to be hierarchical, tangible goods markets tend to be flatter.

### Confidential Reverse Markets Systems/Embodiments of Reverse Markets/Aluminum Foil

Aluminum foil is a global process manufacturing market. Contracts tend to be for long periods, and buyers and sellers are global in nature.

Table 2 describes attributes of the global aluminum foil market.

TABLE 2

| Attribute | data type | matched/other | Buyer | Seller |
|---|---|---|---|---|
| Inquiry period - | date range | y | Inquiry period - | Inquiry period - |
| start date end date | | | start date end date | start date end date |
| delivery | items from | see country | country where | country where seller |
| country | list | preferences | buyer accepts | makes delivery |
| | | | delivery | |
| country | items from | y (but not | seller facility | buyer facility countries |
| preferences | list plus | disclosed to | country that buyer | that seller requires, |
| | integer | the other | requires, prefers, | prefers, disfavors, |
| | ranking - | party) | disfavors, excludes | excludes |
| | required, | | | |
| | preferred, | | | |
| | disfavored, | | | |
| | excluded | | | |
| start date | integer | y | date of first | lead time, expressed as |
| plus | | | delivery expressed | minimum number of days |
| tolerance | | | as number of days | from current system date |
| | | | from inquiry start | (date when matching is |
| | | | date | run) |
| quantity per | decimal/ | y | quantity per | minimum and maximum |
| delivery plus | decimal | | delivery | acceptable quantities per |
| tolerance | | | | period of production |
| end use | hierarchical | y | one end use | all end uses desired for the |
| | lists | | | inquiry |
| width plus | decimal/ | y | width -max and | max width and min width |
| gauge plus | items from a | y | gauge | range of gauges that can |
| tolerance | list/decimal | | | be or are desired to be |
| | | | | produced |
| alloy | items from a | y | usually one item | all alloys produced by the |
| | list | | | mill |
| temper | items from a | y | usually one item | all tempers possible |
| | list | | | |
| finish | text | y | a text description | blank |
| inside | decimal/ | n, | inside diameter | blank |
| diameter plus | decimal | informational | plus tolerance | |
| tolerance | | | | |
| outside | decimal/ | n, | outside diameter | blank |
| diameter plus | decimal | informational | plus tolerance | |
| tolerance | | | | |
| ultimate | text | n, | ultimate tensile | blank |
| tensile | | informational | strength | |
| strength | | | | |
| elongation | text | n, | elongation | blank |
| | | informational | | |
| yield strength | text | n, | yield strength | blank |
| | | informational | | |
| max skid | decimal | n, | max skid weight | blank |
| weight | | informational | | |
| packaging | text | n, | packaging | blank |
| requirements | | informational | requirements | |
| test | boolean | n, | will test deliveries | point of negotiation, |
| deliveries | | informational | be required | usually left blank |
| required | | | | |
| other | text | n n | other | not used |
| | | | requirements, | |
| | | | delivered only to | |
| | | | matched parties | |

The job executable will evaluate each of this items, and provide are report to each party as to failed matches and the reason for the failure. Informational items are delivered only to approved sellers.

### Confidential Reverse Markets Systems/Embodiments of Reverse Markets/Legal Services

Legal services is principally a hierarchical spot market. The system uses geography and hierarchical business attributes to determine the precision of matches.

Table 3 describes example attributes for legal services.

TABLE 3

| Attribute | data type | required | Buyer | Seller |
|---|---|---|---|---|
| Inquiry period - | date range | y y | Inquiry period - | Inquiry period - |
| start date end date | | | start date end date | start date end date |
| type of legal | hierarchical | y y | buyer selects from a | seller selects |
| services | lists such as | | hierarchical list of | offered services |
| | | | legal services types | from the same list |
| | | | that are presented in | |
| | | | a manner understandable | |
| | | | to non-lawyers | |
| geography | items from list - zip | varies | This is linked to the | This enables sellers |
| | code based, important | | type of legal services | to focus on particular |
| | for criminal, real | | hierarchy and is present | market segment |
| | estate, T&E, tax, | | where relevant | |
| | etc., less so for | | | |
| | other practice areas | | | |
| other | text | n, | other requirements, | not used |
| | | informational | delivered only to | |
| | | | matched parties | |

An initial hierarchy of attributes would look like the following:

Criminal
Geography
DUI
Other

Family law
Geography
Financial Planning
   Amount
Divorce
   Financial
   Custody

Business
Employment
   Geography
Corporate
Financial
Real Estate
   Geography
   Amount

Buyer=s inquiries can be as specific down the hierarchy of factors as the buyer makes them. Seller inquiries can likewise be as far down the hierarchy as the sellers make them. Hierarchical factors can include amounts at risk. The system rewards specificity on the part of sellers by ranking them by how far down the hierarchical chains their inquiries matched.

### Supply Chain Collaboration/Overview

This portion of the description is related to the forecasting supply chain collaboration system. The FSCCS provides a secure, multi-party collaborative system for parties managing supply chains and forecasting supply chain planning, production, consumption, and shortfalls and overages. The process can follows the execution of the CRMS.

The overall feature of the FSCCS is multiparty secure collaboration. Unlike typical supply chain software, which is binary buyer and seller, the FSCCS enables secure multi organization collaboration. It does this by linking OUNITS to various parts of the system, enabling collaboration and further at the same time leaving each OUnit in charge of its own employees (in contrast to typical systems which control each individual user, regardless of employer). The host OUnit can assign other OUNITS to various parts of the host OUNITS supply chain, and control whether the invited OUnit has read only read-write rights. The FSCCS also employs vertical partitioning to enable fine tuned control of access to sensitive (typically money related) segments of the supply chain. The FSCCS also uses a work flow modeled on the real world which further enables control over security.

One part of the FSCCS emphasizes long term goods supply chains and long range forecasting so that the effect of current events on supply inventory over long periods of time can be immediately evaluated and appropriate adjustments can be made in a time and cost effective manner, and so that warnings can be issued immediately for exceptions. This version of the FSCCS follows fixes a strict set of base calendar tasks in the structure of the tables, and includes tables for many sub a relatively strict set of steps, from purchase order planning to negotiation to ordering to production to shipping, in order to provide long range forecasts of inventory and long range warnings of shortfalls and overages.

A second part of the FSCCS emphasizes calendar task flexibility so as to better model complex service provisions and at the same time model both simpler goods purchases and less traditional goods purchases schemes. It does this by moving the calendar task system out of the table structure and reducing the complexity of the table structure and additional factors to the calendar task system. It can forecasts cash flows and sequential events as well as providing exception warnings for delayed events.

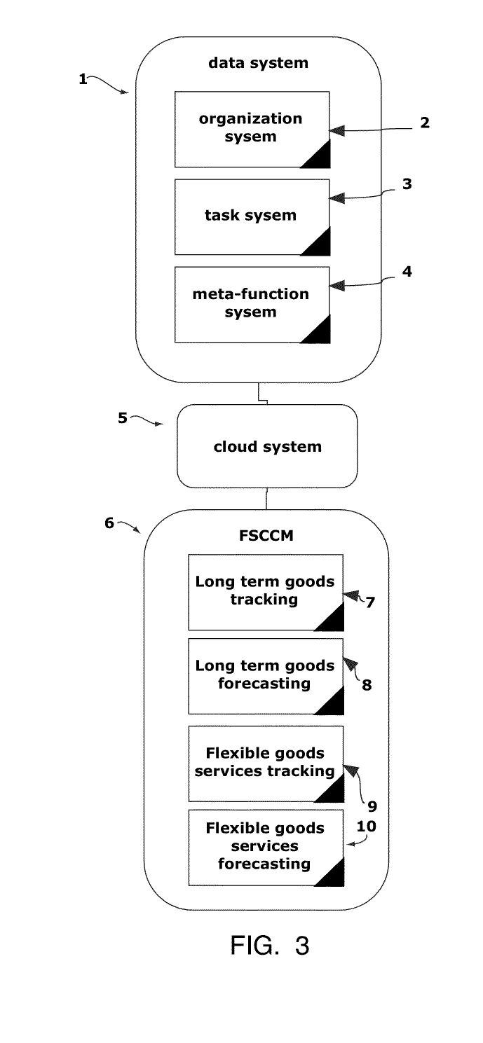

The FSCCS relies on the features of the cross-referenced patent applications. FIG. 3 is an overview of the components of the FSCCS.

FIG. 3, data system, item 1. All components of the data system described in the associated U.S. Provisional Patent Application No. 61/489,596 are used in this system. Special note is taken the multi-level organization system, the task system, the job system and the meta-function system is described in the cross referenced application. Particular use is made of zero parent row, system, vertical partitioning, hierarchical lookups, and relative reminders.

FIG. 3, data system, organization system, item 2. The organization system anticipates large multi organizational unit (AOUnit@) multi-level systems, and single level small organizations. This is supported by a single OUnit table using the parent row zero feature described in the associated U.S. Provisional Patent Application No. 61/489,596.

Users join the system either by signing themselves up or by being signed up by an existing user with authority to do so. If the user is signing themselves up, they are added to a new ounit. If they are signed up by an existing user, then the new user is assigned to the existing user=s ounit or a child OUnit thereof.

Organizations in a global supply chain are customarily large, multi-department organizations, although small suppliers or information providers, intermediaries and shippers are common. Organizational membership is confidential, but organizations can link by sending email requests through the system. This hierarchical OUnit organization is crucial to the security of the system.

FIG. 3, data system, task system, item 3. the task system in this embodiment specifically groups tasks into roles such as buyer, seller, intermediary, and data provider. In addition, links to the supply chain system are by ounit (leaving each OUnit in control of its own security) and then by user (since OUNITS can be from completely different organizations, overall security is by OUnit). The ounit can be restricted to read only. Thus the task system checks both the user=s task and the read-write authority of the ounit. Task assistant and task tracking are emphasized.

The system uses the task system=s grouping mechanism to offer generally two roles, administrator and user. Administrators can create users, child OUNITS and supply chains. Users can be assigned supply chain tasks. Users can have tasks assigned to them, and optionally the ability to assign the same tasks to others. Tasks follow the hierarchy of Organization Unit (parent OUnit)/OUnit/User. Tasks are generally add/edit/view/delete objects in the system.

The task system provides tasks to access each object in the supply chain system (e.g. purchase orders, production orders, delivery orders). Tasks can be read-write or read only. In addition, sensitive information within an object (payments) is separated into separate tasks for finer grain control. To enforce corporate security in a collaborative environment, supply chains are managed by the ounit which creates the supply chain. The host ounit, the ounit that created the supply chain, can execute any task against the supply chain. The host ounit can also assign tasks to other OUNITS to supply chain objects. For example, an intermediary can authorize buyer and seller organizations to manage certain elements of a supply chain=s data, view other elements of a supply chain=s data, and be excluded from other elements of supply chain data. Services providers such as shippers and intermediaries can be granted access to selected objects. OUNITS manage their own users, that is, once an OUnit has been assigned a task, that ounit delegates the task to its own users. This eliminates the problems that would be created if one ounit attempted to manage another ounit=s users.

Table 4 describes the initial setup steps.

TABLE 4

| step | description |
|---|---|
| create forecast | Creation of forecasting record, which |
| system | records the forecast part id, the current |
| | balance, base consumption or production, |
| | and acceptable inventory ranges. This |
| | also includes creating adjustment records. |
| create supply | creation of the supply chain automatically |
| chain | assigns all tasks with full read write |
| | rights to the creating OUnit |
| link ounit to | OUNITS must be linked to supply chain |
| supply chain | objects and optionally given write access |
| object | (in addition to the automatic read access) |
| authorize users | each OUnit assigns tasks to its own users |

When a user attempts to perform a task, the system first checks to see if the ounit has assess to the object involved in the task, and whether that access is read-write or just read-only, and then checks the tasks assigned to the user.

Table 5 describes supply chain task groupings.

TABLE 5

| role | description |
|---|---|
| ounit administrator | create supply chains and accounting records, |
| | authorize other OUNITS to read-write data |
| planning data - goods | manage order planning records |
| and services | |
| production data - goods | manage production records |
| and services | |
| goods shipping data, | manage shipping step records for sellers, |
| buyer, seller, all | buyers or both |
| forecast data | manage forecast data |
| accounting data - invoices | manage invoices |
| accounting data - payments | manage payments and adjustments |

FIG. 3, meta function system, item 4. All features of the meta function system are used but a particular emphasis is placed on the following elements.
collaboration
calendar task tracking
file transfers (CAD drawings, documents)
task tracking and audit systems

In addition to auditing all changes made to all records in the database as described in the database provisional patent application, the educational system tracks all activities on the system. The system tracks all accesses of records in the database and all file accesses. These statistics can be viewed online using the audit toolbar function or downloaded in spreadsheet form.

Table 6 describes the elements of the system that are tracked and audited.

TABLE 6

| component | description |
|---|---|
| audit | the database system audits all changes to all |
| | records in all tables |
| session | all logins and sessions are tracked by the |
| | database system (ip address) |
| object access | all supply chain system object access is |
| tracking | tracked through the task tracking system |
| file download/ | all file/video views are tracked by the |
| uploads | database system |

FIG. 3, cloud system, item 5. The cloud system is described in the cross referenced U.S. Provisional patent application 61/494,465. It is used herein in its entirety.

FIG. 3, FSCCS, item 6. The FSCCS is the data structures and interactions with the data system, job and task system, as well as the other features of the other aforementioned elements, that manage and organize the interaction of the users of the system in a supply chain context.

The supply chain system consists of two main sub-components: the long term goods production and tracking supply chain system and the goods and services supply chain system.
confidentiality among various ounit participants in the supply chain, and, as to each ounit, their employees.
   As noted above, the task system enforces this by enabling the controlling ounit to assign access to each part of the supply chain to specific OUNITS. Task can limit access to each table, and each related set of records (buyer or seller related, payment related, shipper related, warehousing, intermediaries etc.). In addition, tasks can be specified read-write or read only. Each ounit specifies its authorized tasks to its own employees in the same manner, including read-write read-only attributes.
tracking/forecasting supply and payments related thereto
   the system is a tracking/forecasting system. It tracks planning, production and delivery, and payment obligations. As it relates to goods, it is used to track and forecast multi-year delivery systems, years into the future, providing buyers and sellers with an early warning system for overages and underages. As it relates to services, it tracks deliverables and forecasts payments. Actual documents are exchanged through the meta-function system. The forecasting system takes all entries into account in forecasting deliveries and payments, but works backwards through the system to work from the most predictable data to the least, i.e. from buyer delivery table->seller delivery table->production table->purchase order item table to produce the most accurate forecast. The system also enables invoice amounts and payments to be tracked and linked to production and delivery events.

The supply chain system has the following main sub components.

FIG. 3, long term goods tracking, item 7. This part of the system is intended to include in the table flow all of the tasks necessary to track goods production from planning to production to delivery. By building the calendar task system into each of the steps in a predictable structure, efficiency, security and long term planning are enabled.

FIG. 3, long term goods forecasting, item 8. This enables entering min-max on hand inventory quantities, expected consumption rates (or, in the case of sellers, expected production rates), individual date production (or consumption) variations, and is tied to the tracking system by the use of a forecasting part ID to enable the combination of the same part from multiple suppliers or to multiple buyers into a single inbound or outbound forecast. This also forecasts cash flows.

FIG. 3, goods and services tracking, item 9. This is a modified version of the first system, in which production and shipping are removed from the structure and a more flexible calendar task system is substituted. This enables tracking goods and services in a more flexible manner.

FIG. 3, goods and service forecasting, item 10. The forecast system in this version of the FSCCS is a calendar task based forecast, and classifies calendar tasks based on a more complex classification system. This forecasts events and payments.

### Long Term Manufactured Goods Tracking and Forecasting/Process Overview

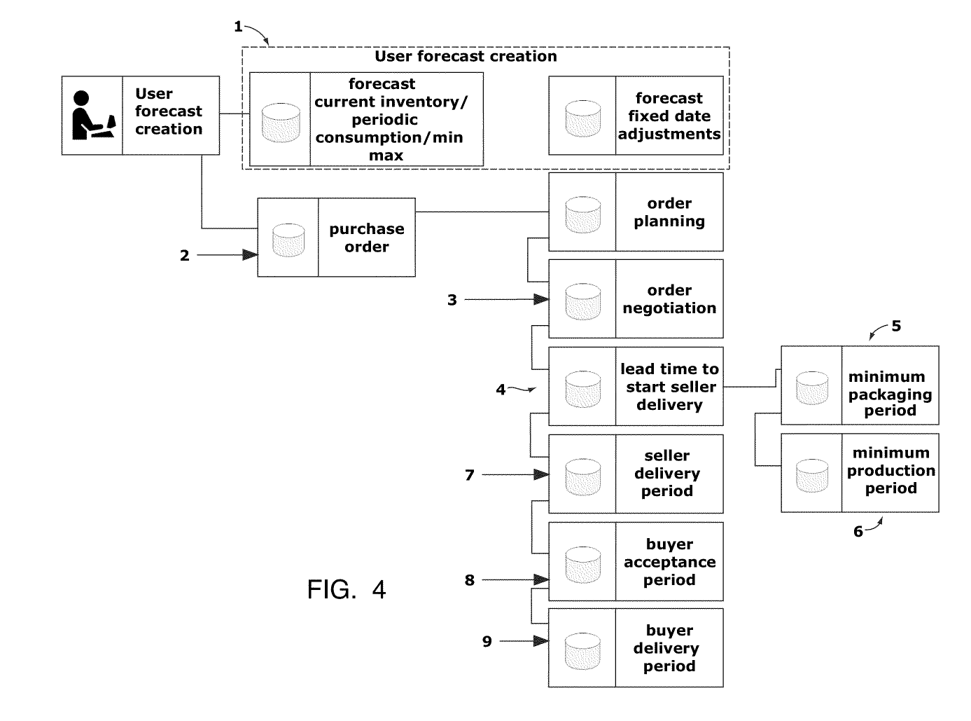

FIG. 4 describes the long term manufactured goods forecasting and tracking process. As explained in more detail following, the process from order planning on is continuous, that is, when one process is completed, the system assumes (and requires) that the next process begins (this is so that responsibility is always clear, and so that time forecasts are complete). As many orders can be scheduled over many years, there can be many order planning start dates. The process described in FIG. 4 is a risk of failure type analysis, that is, the structured events are selected because the successful passing of each event indicates a lowering of risk of a delayed outcome.

FIG. 4, forecast creation, item 1. The forecast for the good=s inventory must be created. The forecast contains the following components:
current inventory quantity (which must be maintained by reference to the actual inventory on hand manually)
forecast periodic consumption (for buyers) or production (for sellers)
minimum and maximum acceptable quantities
fixed date adjustments to the foregoing, that is, from date X to date Y, periodic consumption/production will be Z, or minimum/maximum acceptable quantities will be A.

FIG. 4, purchase order, order planning period, item 2. This is the period during which the buyer plans and evaluates its order. The user determines the typical period. The order negotiation period is assumed to start when this period ends.

FIG. 4, purchase order, order negotiation period, item 3. This is the period during which the buyer and seller negotiate the order. The user determines the typical period. At the end of this period, the system assumes the final purchase order has been accepted by both parties, and the lead time period begins.

FIG. 4, purchase order, lead time to seller start delivery, item 4. This is the period between final order placement and the date on which seller delivery must have commenced in order to maintain the remainder of the scheduled. The longer this lead time, the lower the price (because the seller has more options to schedule the production of the order). The user determines this with respect to user need for promptness balanced by cost. At the end of this period, the seller delivery period begins.

FIG. 4, purchase order, minimum packaging period, item 5. This period is calculated backwards from the end of the preceding period. It is the shortest reasonable period for packaging the goods for shipment once they have been produced so as to maintain the remainder of the schedule. This is tracked to provide an earlier warning for delays than just waiting for the seller delivery date to pass. This information may or may not be made available by sellers in advance and would then have to be estimated by the buyer. In addition, all periods can have a value of zero, meaning not used. Early completion of this period does not automatically advance the remainder of the schedule, but delays in completing this period are assumed to delay the remainder of the schedule.

FIG. 4, purchase order, minimum production period, item 6. This period is calculated backwards form the end of the preceding period. It is the shortest reasonable period for producing the goods so as to maintain the remainder of the schedule. This is tracked to provide an earlier warning for delays than just waiting for the seller delivery date to pass. This information may or may not be made available by sellers in advance and would then have to be estimated by the buyer. In addition, all periods can have a value of zero, meaning not used. Early completion of this period does not automatically advance the remainder of the schedule, but delays in completing this period are assumed to delay the remainder of the schedule.

FIG. 4, purchase order, seller delivery period, item 7. The period during which the goods are in transit between the seller=s production facility and the seller=s delivery city (and includes the time for acceptance by the buyer at the seller delivery city). The buyer delivery period starts when this period ends. For business security reasons, the seller is not customarily given access to tracking information from the seller delivery city to the buyer facility city. Generally, if costs are being tracked on the system, then the seller=s invoice would be delivered at the start of this period.

FIG. 4, purchase order, buyer acceptance period 8. This is the period during which the goods are subject to acceptance by the buyer. This is used primarily as a record to which acceptance documents can be attached.

FIG. 4, purchase order, buyer delivery period 9. This is the period during which the goods are in transit between the seller=s delivery city and the buyer=s delivery city. Buyers frequently do not share this information with sellers, and this information can be segregated from other parties by the creator of the supply chain (which usually is the buyer).

Period budgets are daily, weekly, semi-monthly, monthly and Sundays and Saturdays can be excluded from the calculation. Initial time forecasts, current forecasts, and actuals, are recorded.

### Long Term Manufactured Goods Tracking and Forecasting/Detail

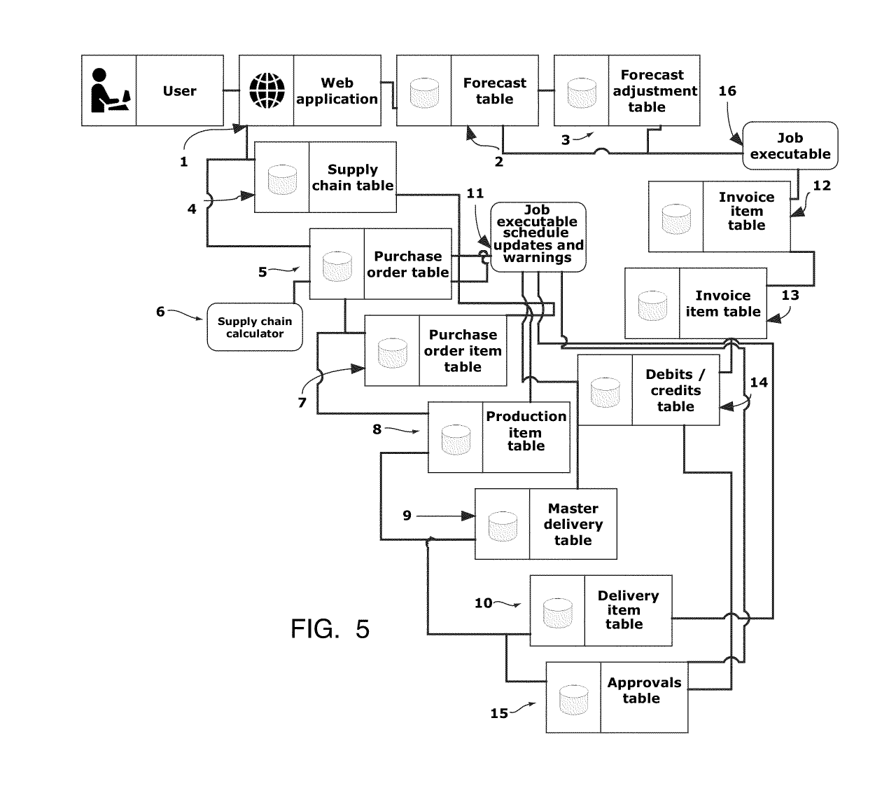

FIG. 5 describes the long term manufactured goods supply chain collaboration system in detail.

FIG. 5, web application, item 1. The web application ensures that user data updates are consistent—dates cannot be illogical (a subsequent date prior to a previous date), delivery chains are complete (each row starts where the previous row ended and the chain itself starts and ends in the predetermined cities). Delivery time budgets are assumed to be 200 nautical miles per day where necessary.

FIG. 5, forecast table, item 2. The forecast table is the organizing table for all quantity and expenditure forecasts. Each row in the forecast table represents a forecast for a single good. The forecast row can then be attached to as many purchase order items in as many supply chains as needed. A forecast row can be created by a buyer or a seller. The forecast row contains the following fields:
consumption or production forecast
current on hand inventory quantity
minimum and maximum permissible inventory quantities
forecast periodic consumption/production quantities and the associated period

FIG. 5, forecast adjustment table, item 3. In order to take into account known future events that will affect the forecasts (seasonality, unusual orders or events), the forecast adjustment table enables fixed future period specific changes to the standard amounts in the forecast table. It includes the following fields:
substitute minimum and maxim permissible inventory quantities, and the associated start date and end date for the period
substitute consumption/production quantities and the associated start date and end date for the period

FIG. 5, supply chain table, item 4. The supply chain table acts as a master security and organization bucket for the ounit of the buyer and the seller and the other collaborating OUNITS related to the supply relationship (shipping, customs, intermediaries). The ounit which creates the supply chain record completely controls all records and tasks associated with that record, including delegation of tasks to other OUNITS. It records
the creating ounit
buyer name, seller name (for search and system organization purposes)
description (usually of product, for search and system organization purposes)
start date/end date

FIG. 5, purchase order table, item 5. The purchase order table organizes the individual purchase, production and delivery tracking transactions. It contains:
(usually available to the buyer only)
the initial planned/current planned/actual date for planning start
time budget for planning
the initial planned/current planned/actual date for order negotiation with the seller
time budget for order negotiation

Using a vertical partition, the purchase order makes following data available to the buyer and seller: buyer and seller, purchase order ID and date once the purchase order is finalized and delivered to the seller.

FIG. 5, supply chain calculator, item 6. The supply chain calculator is a tool (supported by a child table to the purchase on the purchase order that enables rapid planning and construction of supply chains. The calculator initially works backwards from the buyer acceptance date but once set up, any date in the sequence can be calculated from any other and then added to the chain:
seller facility city, seller delivery city, buyer facility city
buyer final delivery date
buyer delivery period
buyer acceptance period
seller delivery period
packaging period
production period
order to seller delivery lead time
order negotiation period
order planning period

Any date in the chain can be used as the anchor from which all forward and backward dates can be calculated. The purchase order can then add a purchase order item based on the schedule. The system will then recalculate the goods and financial forecasts, to enable the user to determine the effect of new and amended purchase orders. The calculator can also add purchase order items to the purchase order based on these schedules.

FIG. 5, purchase order item table, item 7. This is a child of the purchase order table and records individual purchase order items, and is the parent of production items, delivery tracking items and can be linked to invoice items)

In one vertical partition, the following data is stored (and usually made available to the buyer and seller):
buyer and seller purchase order item ID
the buyer, seller and other product ID
description
quantity, quantity units and quantity tolerance

In a separate vertical partition, the following data is stored
link to the forecast table
current quantity not in production items
current quantity not in packaging
current quantity not in seller delivery
current quantity not in buyer acceptance
current quantity not in buyer delivery
completion flag (no longer in forecast)

The buyer will usually not make this information available to other parties. However, the system allows other parties to create their own records in this table to power their own forecasts (usually this would be the seller). The purpose of these amounts is to provide final accuracy for the forecasts (as actual quantities produced and ship can vary from the forecast quantities).

In a separate vertical partition, time forecast data is stored, usually for the benefit of the buyer:
initial planned/current planned/actual start/finish date for packaging
time budget for packaging
initial planned/current planned/actual start/finish date for production
time budget for production
seller=s facility city (where delivery starts)
seller delivery city (where the seller is shipping to)
initial planned/current planned/actual start/finish date for seller delivery
time budget for delivery
initial planned/current planned/actual start/finish date for buyer acceptance
time budget for buyer acceptance
the buyer facility city
time budget for delivery
initial planned/current planned/actual start/finish date for buyer delivery

In a separate vertical partition, the following data elements are stored (money elements generally attract particular levels of security)
forecasted payment event date: fixed date/production start/production end/seller delivery start/seller delivery end
time budget from that date plus or minus
initial planned/current planned/actual payment date
payment currency, price per unit
quantity payment
other charges
description of other charges
remaining un-invoiced amount
remaining un-paid amount

FIG. 5, production item table, item 8. This is a child of the purchase order item table and records individual production items. Use of this table is optional, since not all manufacturers will cooperate with buyers to provide the data. In addition, sellers can add a row to this table and not permit buyers to see it. Buyers can add a row to help refine their forecasts. In a vertical partition usually available to the buyer and the seller, the following data is stored:
the seller and other product ID
description
quantity and quantity units scheduled
quantity in production
quantity produced
quantity packaged
completion flag

In a separate vertical partition, the buyer and seller can each secure the following data:
link to the forecast table
initial planned/current planned/actual start/finish date for production
time budget for production
initial planned/current planned/actual start/finish date for production/start date for packaging
time budget for packaging

FIG. 5, master delivery table, item 9. This is a child of the purchase order item table and can be linked to the production table. It tracks shipment from seller facility city to seller delivery city and then buyer acceptance, and then tracks delivery from the seller delivery city to the buyer facility. It then tracks delivery from the seller delivery city to the buyer facility. It records the starting city, the ending city and has a completion flag. This seller portion of the route is usually made available to the seller and buyer, while the buyer portion of the route is usually made available only to the buyer. It can also organize deliveries that are split later in the route, that is, a single unit travels part of the route, and then is split into multiple independent deliveries. It does this using the route ID field.

FIG. 5, delivery item table, item 10. This is a child of the master delivery table, and records all steps in the shipping process, one row per step, with a minimum of three rows—seller delivery from seller facility to seller delivery city, buyer acceptance, buyer delivery from seller delivery city to buyer facility. It records in each step
route ID and the parent row id (for split deliveries)
buyer or seller delivery flag for security purposes
starting and ending city
mode of transport (ship, rail, plane, truck, storage, acceptance)
vehicle or warehouse ID
container ID
other tracking ID
quantity and quantity units
initial planned, current planned/actual start date
initial planned, current planned/actual time en route
initial planned, current planned/actual arrival date

FIG. 5, job executable schedule updates and warnings, item 11. The job executable checks every record in the supply chain once per day, starting with purchase order s and ending with buyer delivery. If a time budget is not completed and has a current projection of the current day, the current projection is changed to the next succeeding in accordance with the associated time period. Then, each child record thereof is checked, and the current projection dates advanced if either a parent record has been advanced or the current projection date is the current date. In this way, the job executable keeps all projections current. Notices are sent based on user specifications (e.g. the day before an event, an event that is overdue, etc.), using the associated events table and user list and information provider list table.

FIG. 5, invoice table, item 12. The invoice table is an independent organizing table. it records the invoice number and date. It can be maintained by any party authorized by the supply chain creator.

FIG. 5, invoice item table, item 13. This is a child of the invoice table. it records:
link to purchase order item
link to production order
link to seller delivery record
description of good or service
quantity and quantity units
price per quantity and total amount
payment currency
quantity payment
remaining unpaid amount
initial planned/current planned/actual payment date

FIG. 5, debit/credit table, item 14. This is a child of the invoice item table. It documents the initial invoice amount, and then documents payments and adjustments to the invoice item amount. Tt records
date
increase/decrease
amount
description

FIG. 5, approvals table, item 15. The approval system enables users to approve purchase order records and the other records in the chain (purchase order items and production items) and all linked file uploads. This enables collaboration among the parties re the substantive terms of the transactions that are contained in attached documents as well as the scheduling data in the system.

FIG. 5, job executable forecasts, item 16. Once day the job executable prepares a forecast for all forecasts on the system. It forecasts min/max quantity compliance by calculating the amounts projected to arrive day by day through the supply chain, by first looking at the buyer delivery rows, then the seller delivery rows, then the production item rows, then the purchase order items. It calculates the forecast requirements by checking each forecast table and associated forecast adjustment rows to produce a daily requirements amount for as far out as the supply chain goes plus 3 months. It compares the two streams, and warns the listed users when a forecast min/max amount is breached. Notices are sent based on user specifications (e.g. the day before an event, an event that is overdue, etc.). It also forecasts payments amounts by working back from invoices to delivery production items to purchase order items.

### Long Term Manufactured Goods Tracking and Forecasting/Scenario

The following is one typical scenario based on this embodiment. Process run manufacturers such as oil refining and metal smelting profits are dependent on minimizing job setup time by running large jobs. They give favorable price concessions to customers who place large predictable orders and customers who grant some leeway as to exact production dates. These manufacturers look to combine small jobs into larger jobs.

Using the described system, a customer can place a periodic (e.g. monthly) order covering a multi-year period. The supply chain calculator builds a schedule for each order, from order planning to buyer delivery. Then the notification function keeps each order on track.

The forecasting system makes sure that required min/max quantities over future periods are satisfied, and provides instant forecasts of the consequences of supply disruption, potentially many months in advance of the problem, when disruptions occur.

### Flexible Goods and Services Collaboration System

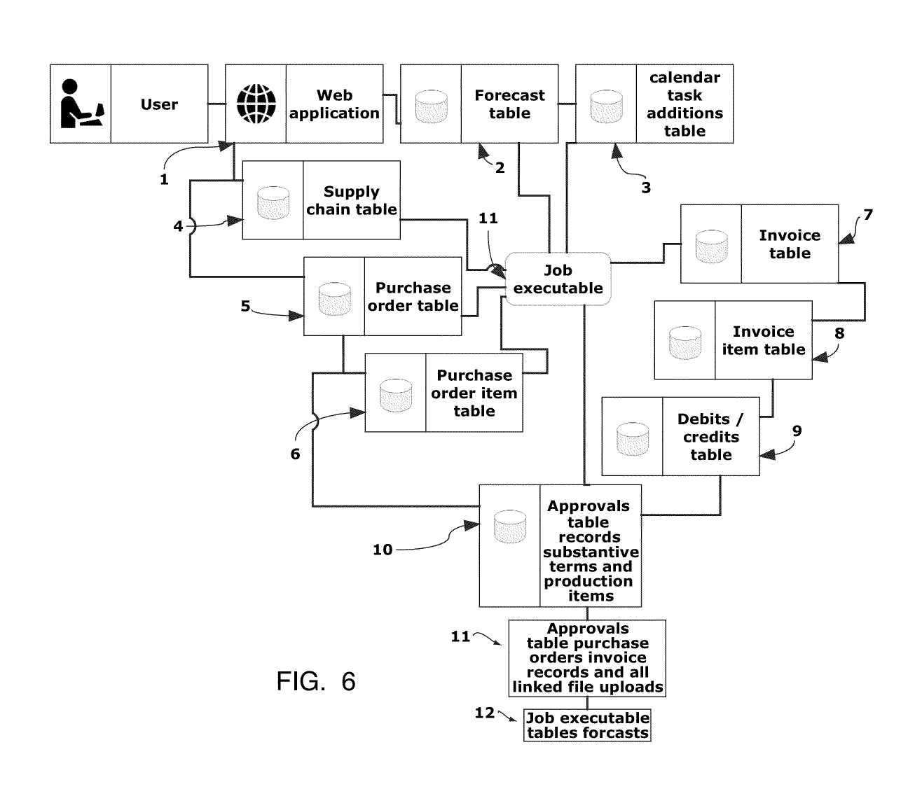

The flexible goods and services collaboration system makes a number changes to the goods system. The chief among these is that forecasting is based on the separate calendar task system, with certain vertical partition table additions made to the general calendar task system. Also, the production and shipping tables are not used, and the calendar task system as modified are used instead. FIG. 6 describes the flexible goods and services collaboration supply chain system in detail.

FIG. 6, web application, item 1. The web application working with the task system presents this system to the user and ensures that user data updates are consistent—for example, dates cannot be illogical (a subsequent date prior to a previous date).

FIG. 6, forecast table, item 2. The forecast table in this system is intended to organize calendar tasks associated with disparate records into an organized coherent system. The forecast system adds a vertical partition to the general calendar task system which classifies calendar tasks into payments, start of deliverables, end of deliverables, approvals, and all other. As a result, the forecast system can project delivery and payments for a disparate universe of good and services. There is also a secondary title field used in connection with all classes, and is displayed by the forecast projections in the case of all other. The rows in this table act as the parent table to purchase order items using the forecast link. It reaches through the purchase order items to track the calendar tasks.

FIG. 6, calendar task table, item 3. The system adds a vertical partition to the calendar task table to expand forecasting capabilities. This table classifies calendar tasks into delivery start, delivery end, approvals, payments, and other. It also records quantities in the case of deliveries, and amounts in the case of payments. As noted in the related patents, this is a hierarchical system that supports date dependencies among calendar tasks, and can support complex project paths.

FIG. 6, supply chain table, item 4. The supply chain table acts as a master security and organization bucket for the ounit of the buyer and the seller and the other collaborating OUNITS related to the supply relationship. The ounit which creates the supply chain record completely controls all records and tasks associated with that record, including delegation of tasks to other OUNITS. It records
the creating ounit
description (usually of the project or service for search and system organization purposes)
initial planned/current planned/actual start date
initial planned/current planned/actual finish date

FIG. 6, purchase order table, item 5. This is the organizing table for particular purchases. It records
the buyer and seller,
initial planned, current planned and actual start and end dates, the PO date,
the purchase order ID
parent row dependency to a parent purchase order

As with every other table, calendar tasks for particular purposes can be attached to this table. Rows in this table can be made hierarchical through the parent row zero feature, making dates in one purchase order dependent on the parent=s dates.

FIG. 6, purchase order item table, item 6. This is a child of the purchase order table and records individual goods and service items and can be linked to invoice items)
link to forecast table
description of good or service
quantity and quantity units
price per quantity and total amount
initial planned, current planned and actual start and end dates, the PO date,
the purchase order item ID
parent row dependency to a parent purchase order item

This table is the primary user of the calendar task system. Rows in this table can be made hierarchical through the parent row zero feature, making dates in one purchase order dependent on the parent=s dates.

FIG. 6, invoice table, item 7. The invoice table is an independent organizing table. it records the invoice number and date.

FIG. 6, invoice item table, item 8. This is a child of the invoice table. it records:
link to purchase order item
description of good or service
quantity and quantity units
price per quantity and total amount
payment due date

This table also makes central use of the calendar task system, from the perspective of the seller.

FIG. 6, debits-credits table, item 9. This is a child of the invoice item table. It documents payments and adjustments to the invoice item amount. It records
date
increase/decrease
amount
description

FIG. 6, approvals table, item 10. The approval system enables users to approve purchase order records and the other records in the chain (purchase order items and production items) and all linked file uploads. This enables collaboration among the parties re the substantive terms of the transactions that are contained in attached documents as well as the scheduling data in the system.

FIG. 6, job executable table, item 11. Once day the job executable prepares a forecast for all forecasts on the system. In this system, this is a forecast based on calendar task types, and includes all start and end delivery times, payments, approvals and other events.

The job executable also checks every calendar task. If a time budget is not completed and has a current projection of the current day, the current projection is changed to the next succeeding business day (m-f). Then, each child record thereof is checked, and the current projection dates advanced if either a parent record has been advanced or the current projection date is the current date. In this way, the job executable keeps all projections current. Notices are sent based on user specifications (e.g. the day before an event, an event that is overdue, etc.).

### Flexible Goods and Services Collaboration System/Scenario

The following is one typical scenario based on this embodiment. A merger/acquisition transaction is a complex, multi party, hierarchical service project. A number of lead service providers will be retained, including investment banking firms and law firms. Purchase orders can be planned hierarchically to allow planning of dependent events, and security can be made collaborative with each purchase order, so that if multiple parties can approve the work online Calendar tasks related to date dependent purchase order items are updated automatically from date changes with parent items and users are notified of violation of time constraints. Individual invoice items can be matched against authorizing purchase order items to manage work. Complex calendar task hierarchies can be created, dependent on each other and on date fields in the purchase order, purchase order item and invoice item tables. Cash flow and calendar task forecasts are updated automatically as dependent dates change.

### Additional Embodiments

The system as described uses the technology of one type of cloud system but can be extended to any server system. It can use any appropriate open source or proprietary software for processes such as compression, encryption, video encoding, etc.

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### CONCLUSION, RAMIFICATIONS AND SCOPE

The system described herein contains all of the advantages described in the associated patents

### CRMS

One important benefit of the CRMS is confidentiality. In contrast to current online markets, this market is entirely confidential. No buy or sell inquiries are generally disclosed. No participant identities are generally disclosed. Buyers and sellers can participate in the market without disclosing business information directly or by inferences drawn from their market activities. Buyers can search for new vendors and sellers can search for new customers without upsetting existing relationships. Both buyers and sellers can post their entire future consumption/production needs in complete security.

Another important benefit of the market is efficiency. Buyers=search process is improved by connecting buyers only to sellers who are actively interested in the buyer=s inquiry. In most online markets, buyers must wade through many apparently qualified sellers who are not actually interested in the buyer=s business, for any number of reasons, including capacity constraints, revenue interests, and misidentification of the seller=s qualifications in the search process. The seller=s opportunity to examine the buyer=s inquiry before the seller confirms interest allows the sellers to discard uninteresting inquiries. Seller=s search efficiency is improved by virtue of the specificity that sellers can employ in crafting sell inquiries, free from the problem of leaking competitive information by inference. Sellers can specify precisely what they want without alerting competitors or potential customers to possible negotiating leverage.

Another advantage of the market is speed of development. The system is based on hierarchical self-referencing table, and elements of each market can be added and removed with no recorded. The market structures are directly translatable into a spreadsheet format, making development extremely efficient.

### Long Term Forecast Supply Chain Collaboration System

### Benefits/Goods Supply Chain

The goods supply chain system includes the following benefits:
multiple company secure collaboration on a single supply chain: The system enables multi-company secure collaboration on a single supply chain. Multiple companies, including buyers, sellers, intermediaries, and service providers can be given secure access to the system to add/edit data and respond to reports and events. Delegation to individual users is controlled by each company.
complete process tracking, from order planning to production to packaging to shipping: The entire production process from order planning to buyer delivery is tracked and checked for consistency.
automatic warnings to users of time constraint violations, with automatic schedule updates: Users are notified daily of violations of time constraints, money constraints and quantity constraints. The system is maintained in an internally consistent condition as to dates, quantities and money amounts.
forecasting up to multi-year supply chains, with automatic warning to users of violations of quantity constraints: The forecasting system works from buyer delivery back to order planning to forecast incoming/outgoing supply. It then compares it to the forecast required min/max data, and warns users of violations, potentially months and years before the violations occur, giving participants the maximum time to make adjustments.
multi-supplier part forecasting: Parts being sourced by more than one supplier can be included in a single supply chain, without security breaches.
multi-year cash forecasting: The cash forecasting system works from buyer delivery back to order planning to forecast incoming/outgoing supply using the payment information associated with each type of record. It then provides a complete cash flow forecast, which is maintained in an up-to-date internally consistent manner, reflecting all changes made to the system by any user.
planning calculator: The system includes a planning calculator which enables the rapid employment of new purchase orders on a planning basis. The calculator, combined with the forecast system, enables immediate what-if supply chain calculations making complex, long-term adjustments to the supply chain to address disruptions an immediate process.

### Benefits/Services Supply Chain

The services supply chain includes the following benefits:
multiple company secure collaboration on a single supply chain: The system enables multi-company secure collaboration on a single supply chain and on individual transactions. Multiple companies, including buyers, sellers, intermediaries, and service providers can be given secure access to the system to add/edit data and respond to reports and events. Delegation to individual users is controlled by each company, placing user security in the correct locations.
complete process tracking, with hierarchical dependent service providers: The project is managed in a hierarchical manner, with dependent purchase orders added as children of parent purchase orders. Purchase orders can be issued automatically as the project progresses. Individual service charge elements can be matched against individual purchase order items.
automatic warnings to users of time constraint violations, with automatic schedule updates: The system automatically notifies users of time and budget violations, and updates date constraints automatically. If the finish date of one purchase order is delayed, the start date of dependent purchase orders is likewise delayed.
multi-year cash forecasting: The cash forecasting system works by reviewing each purchase order, purchase order item and service item, and the finance objects. It then provides a complete cash flow forecast, which is maintained in an up-to-date internally consistent manner, reflecting all changes made to the system by any user.

We claim:

1. A method of matching buying inquiries and sell inquiries in an automated marketplace system and tracking the process of the fulfillment of said buying and selling.

2. The method of claim 1, further comprising maintaining confidentiality of buyer and seller identities throughout the method.

3. The method of claim 2, further comprising ranking the desirability of each matched buy and sell inquiry to each party (buyer and seller) based on criteria determined by each party.

4. The method of claim 1, further comprising a method of approval wherein the first party (buyer or seller) approves the identity of second party, the second party approves the content of the buyer inquiry, and the second party approves the identity of the first party.

5. The method of claim 1, further comprising tracking and forecasting said supply chain process.

6. The method of claim 1, wherein the method allows for collaboration among the parties to a supply chain.

7. The method of claim 6, further comprising security groupings controlled by one party to said supply chain system that enables said party to assign tasks to other parties.

8. The method of claim 6, further comprising tracking the entire production, delivery, and payment process.

9. The method of claim 6, further comprising forecasting production, delivery and inventory consumption to provide forecasts comprising daily and yearly ranges.

10. The method of claim 6, further comprising tracking dates associated with events in the supply chain.

11. A system with a means of matching buying inquiries and sell inquiries in an automated marketplace system and tracking the process of the fulfillment of said buying and selling.

12. The system of claim 1, further comprising with a means of maintaining confidentiality of buyer and seller identities throughout the method.

13. The system of claim 2, further comprising with a means of ranking the desirability of each matched buy and sell inquiry to each party (buyer and seller) based on criteria determined by each party.

14. The system of claim 1, further comprising with a means of approval wherein the first party (buyer or seller) approves the identity of second party, the second party approves the content of the buyer inquiry, and the second party approves the identity of the first party.

15. The system of claim 1, further comprising with a means of tracking and forecasting said supply chain process.

16. The system of claim 1, wherein the system allows for collaboration among the parties to a supply chain.

17. The system of claim 6, further comprising security groupings controlled by one party to said supply chain system that enables said party to assign tasks to other parties.

18. The system of claim 6, further comprising with a means of tracking the entire production, delivery, and payment process.

19. The system of claim 6, further comprising with a means of forecasting production, delivery and inventory consumption to provide forecasts comprising daily and yearly ranges.

20. The system of claim 6, further comprising with a means of tracking dates associated with events in the supply chain.
